(19) United States
(12) Patent Application Publication
(10) Pub. No.: US 2025/0211963 A1
(43) Pub. Date: Jun. 26, 2025

(54) COMMUNICATION CONTROL DEVICE, TERMINAL DEVICE, COMMUNICATION CONTROL METHOD, AND RECORDING MEDIUM

(71) Applicant: NEC Corporation, Minato-ku, Tokyo (JP)

(72) Inventors: Kazuki OGATA, Tokyo (JP); Yuji SATO, Tokyo (JP); Jun TAKASAWA, Tokyo (JP); Hideki RIKKAWA, Tokyo (JP)

(73) Assignee: NEC Corporation, Minato-ku, Tokyo (JP)

(21) Appl. No.: 18/850,125

(22) PCT Filed: Mar. 30, 2022
(86) PCT No.: PCT/JP2022/016100

§ 371 Date: Sep. 24, 2024

(51) Int. Cl. H04W 8/00; H04W 64/00; H04W 76/10

(52) U.S. Cl. CPC H04W 8/005; H04W 64/006; H04W 76/10

(57) ABSTRACT

To provide a technique that makes it possible to immediately establish connection when a terminal apparatus moves from outside a cell into the cell, a communication control apparatus includes: a determination section (11) that determines whether a target terminal apparatus (100) has approached a cell (Cell01) which a base station manages; and a communication control section (12) that increases the frequency of cell searches which are conducted by the target terminal apparatus for connection to the cell, in a case where the determination section determines that the target terminal apparatus has approached the cell.

### TECHNICAL FIELD

The present invention relates to a communication control apparatus, a terminal apparatus, a mobile body, a communication system, a communication control commercial law, and a program.

### BACKGROUND ART

There is known a communication system in which a base station and a terminal apparatus carries out communication with each other. In such a communication system, for each of a plurality of base stations, a spatial area (cell) which is covered by the each of the plurality of base stations is set, and the each of the plurality of base stations carries out communication with a terminal apparatus that is present in the cell (for example, Patent Literature 1).

In order to realize communication as described above, the terminal apparatus is generally configured to conduct a cell search under a given condition.

### CITATION LIST

### Patent Literature

### [Patent Literature 1]

Japanese Patent Application Publication Tokukai No. 2003-199137

### SUMMARY OF INVENTION

### Technical Problem

In general, a terminal apparatus moves. Therefore, there is a case where the terminal apparatus moves from an area which is not covered by any base station to a cell of any base station. In this case, even in a case where the technique disclosed in Patent Literature 1 is used, a problem that connection with the base station is not immediately established occurs.

An example aspect of the present invention has been made in view of the above problem, and an example object thereof is to provide a technique which makes it possible to immediately establish connection when a terminal apparatus moves from outside a cell into the cell.

### Solution to Problem

A communication control apparatus in accordance with an example aspect of the present invention includes: determination means for determining whether a target terminal apparatus has approached a cell which a base station manages; and a communication control means for increasing a frequency of cell searches which are conducted by the target terminal apparatus for connection to the cell, in a case where the determination means determines that the target terminal apparatus has approached the cell.

A terminal apparatus in accordance with an example aspect of the present invention includes: a determination means for determining whether the terminal apparatus has approached a cell which a base station manages; and a communication control means for increasing a frequency of cell searches for connection to the cell, in a case where the determination means determines that the terminal apparatus has approached the cell.

A mobile body in accordance with an example aspect of the present invention includes: a determination means for determining whether the mobile body has approached a cell which a base station manages; and a communication control means for increasing a frequency of cell searches for connection to the cell, in a case where the determination means determines that the mobile body has approached the cell.

A communication system in accordance with an example aspect of the present invention is a communication system including a terminal apparatus and a roadside apparatus, the terminal apparatus including: a determination means for determining whether the terminal apparatus has approached a cell which a base station manages; and a communication control means for increasing a frequency of cell searches for connection to the cell, in a case where the determination means determines that the terminal apparatus has approached the cell, the roadside apparatus making a notification with respect to the terminal apparatus, the determination means determining that the terminal apparatus has approached the cell, based on the notification.

A communication system in accordance with an example aspect of the present invention is a communication system including a terminal apparatus and another mobile body that is different from a mobile body to which the terminal apparatus is mounted, the terminal apparatus including: a determination means for determining whether the terminal apparatus has approached a cell which a base station manages; and a communication control means for increasing a frequency of cell searches for connection to the cell, in a case where the determination means determines that the terminal apparatus has approached the cell, the another mobile body making a notification with respect to the terminal apparatus, the determination means determining that the terminal apparatus has approached the cell, based on the notification.

A communication control method in accordance with an example aspect of the present invention is a communication control method carried out by a communication control apparatus, including: determining whether a target terminal apparatus has approached a cell which a base station manages; and increasing a frequency of cell searches which are conducted by the target terminal apparatus for connection to the cell, in a case where a determination means determines that the target terminal apparatus has approached the cell.

A in accordance with an example aspect of the present invention is a program for causing a computer to function as a communication control apparatus, the program causing the computer to function as: a determination means for determining whether a target terminal apparatus has approached a cell which a base station manages; and a communication control means for increasing a frequency of cell searches which are conducted by the target terminal apparatus for connection to the cell, in a case where the determination means determines that the target terminal apparatus has approached the cell.

### Advantageous Effects of Invention

An example aspect of the present invention makes it possible to immediately establish connection when a terminal apparatus moves from outside a cell into the cell.

### BRIEF DESCRIPTION OF DRAWINGS

FIG. 1 is a drawing illustrating an example of a configuration of a communication system in accordance with a first example embodiment of the present invention.

FIG. 2 is a flowchart illustrating a flow of processes in a communication control method in accordance with the first example embodiment of the present invention.

FIG. 3 is a drawing illustrating an example of a configuration of another communication system in accordance with the first example embodiment of the present invention.

FIG. 4 is a drawing illustrating an example of a configuration of another communication system in accordance with the first example embodiment of the present invention.

FIG. 5 is a drawing illustrating an example of a configuration of a communication system in accordance with a second example embodiment of the present invention.

FIG. 6 is a drawing illustrating an example of a configuration of a communication system in accordance with a third example embodiment of the present invention.

FIG. 7 is a drawing illustrating movement of a mobile body during a determination process of the communication system in accordance with the third example embodiment of the present invention.

FIG. 8 is a drawing illustrating an example of a configuration of a communication system in accordance with a fourth example embodiment of the present invention.

FIG. 9 is a drawing illustrating movement of a mobile body during a determination process of the communication system in accordance with the fourth example embodiment of the present invention.

FIG. 10 is a block diagram illustrating an example of a hardware configuration of an information processing apparatus in accordance with each of the example embodiments of the present invention.

### EXAMPLE EMBODIMENTS

### First Example Embodiment

The following description will discuss a first example embodiment of the present invention in detail with reference to the drawings. The present example embodiment is a basic form of example embodiments described later.

### (Configuration of Communication System 1000)

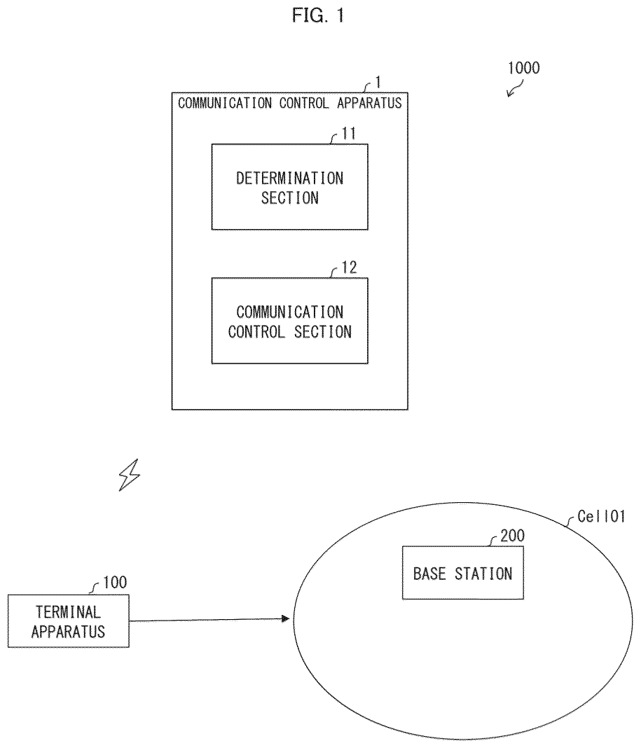

A configuration of a communication system 1000 in accordance with the present example embodiment is described with reference to FIG. 1. FIG. 1 is a drawing illustrating an example of the configuration of the communication system 1000. As illustrated in FIG. 1, the communication system 1000 includes, as an example, a communication control apparatus 1, a terminal apparatus 100, and a base station 200. As illustrated in FIG. 1, the base station 200 provides a cell (Cell01) as a communication area which the base station 200 manages.

Note that, in the communication system 1000, the communication control apparatus 1 may be provided within the terminal apparatus 100, may be provided within the base station 200, may be provided within another apparatus, or may be realized as an apparatus separate from any apparatus.

As illustrated in FIG. 1, the communication control apparatus 1 includes a determination section 11 and a communication control section 12. The determination section 11 and the communication control section 12 are configurations which realize a determination means and a communication control means, respectively, in the present example embodiment. The determination section 11 determines whether the target terminal apparatus 100 has approached the cell (Cell01) which the base station 200 manages.

In a case where the determination section 11 determines that the target terminal apparatus 100 has approached the cell (Cell01), the communication control section 12 increases the frequency of cell searches which are conducted by the target terminal apparatus 100 for connection to the cell.

As an example, in a case where the communication control apparatus 1 is provided within the terminal apparatus 100, the communication control section 12 controls a communication module of the terminal apparatus 100 so as to increase the frequency of the cell searches which are conducted by the communication module.

As another example, in a case where the communication control apparatus 1 is provided as an apparatus separate from the terminal apparatus 100, the communication control section 12 carries out communication with the terminal apparatus 100 and controls the communication module of the terminal apparatus 100 through the communication so as to increase the frequency of the cell searches which are conducted by the communication module.

Note that a degree to which the communication control section 12 increases the frequency of the cell searches does not limit the present example embodiment, but, as an example, can be expressed as below in a case where the frequency of the cell searches when the determination section 11 determines that the target terminal apparatus 100 is not approaching the cell (Cell01) which the base station 200 manages is expressed as F1 and the frequency of the cell searches when the determination section 11 determines that the target terminal apparatus 100 has approached the cell (Cell01) which the base station 200 manages is expressed as F2.

$$F 2 = α \cdot F 1$$

Note, here, that the coefficient α is a real number greater than 1, and the symbol “.” represents an operation that takes a product. As an example, α may be 2, 5, or 10.

A specific threshold for a determination of approach which determination is made by the determination section 11 also does not limit the present example embodiment. As an example, the threshold may be set to an average value of radii of cells which a plurality of base stations provide, and, in a case where a distance between the target terminal apparatus 100 and the base station 200 becomes equal to or less than the threshold, the determination section 11 may determine that the target terminal apparatus 100 has approached the cell (Cell01). Note that the expression “increasing the frequency of the cell searches” does not limit the present example embodiment, but, as an example, may be prolonging the durations of the cell searches and shortening idle times.

As an example, the determination section 11 may determine whether the target terminal apparatus 100 has approached the cell (Cell01), based on a result of comparing (i) positional information pertaining t terminal apparatus 100 or positional information pertaining to a mobile body to which the target terminal apparatus 100 is mounted and (ii) positional information associated with the cell (Cell01) which the base station 200 manages.

The determination section 11 may determine that the target terminal apparatus 100 has approached the cell (Cell01), upon receipt of a notification from another apparatus.

### (Effect of Communication System 1000)

In the communication system 1000 configured as described above, the communication control apparatus includes the above-described determination section 11 and the above-described communication control section 12. The communication control apparatus 1 thus configured makes it possible to immediately establish connection when the terminal apparatus 100 moves from outside the cell into the cell.

### (Flow of Communication Control Method S1)

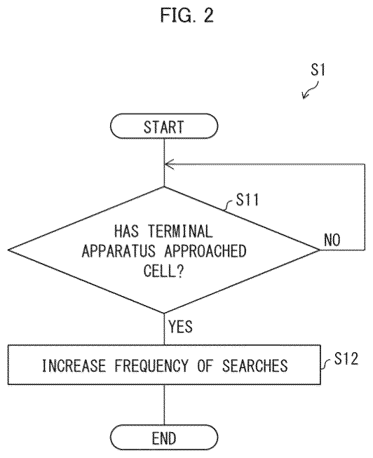

Next, a flow of a communication control method S1 in accordance with the present example embodiment is described with reference to FIG. 2. FIG. 2 is a flowchart illustrating a flow of processes in the communication control method S1.

### (Step S11)

First, in a step S11, the determination section 11 of the communication control apparatus 1 determines whether the target terminal apparatus 100 has approached the cell (Cell01) which the base station 200 manages. In a case where the determination section 11 determines that the target terminal apparatus 100 has approached the cell (Cell01) which the base station 200 manages (YES in the step S11), the method proceeds to a step S12. Otherwise, the process in the step S11 is repeated.

### (Step S12)

In a case where the determination section 11 determines, in the step S11, that the target terminal apparatus 100 has approached the cell (Cell01) which the base station 200 manages, the communication control section 12 of the communication control apparatus 1 increases, in the step S12, the frequency of the cell searches which are conducted by the target terminal apparatus 100 for connection to the cell (Cell01).

### (Effect of Communication Control Method S1)

In the communication control method S1 configured as described above, the communication control apparatus 1 includes the above-described determination step (step S11) and the above-described communication control step (step S12). The communication control method S1 thus configured makes it possible to immediately establish connection when the terminal apparatus 100 moves from outside the cell into the cell.

### (Configuration of Communication System 2000)

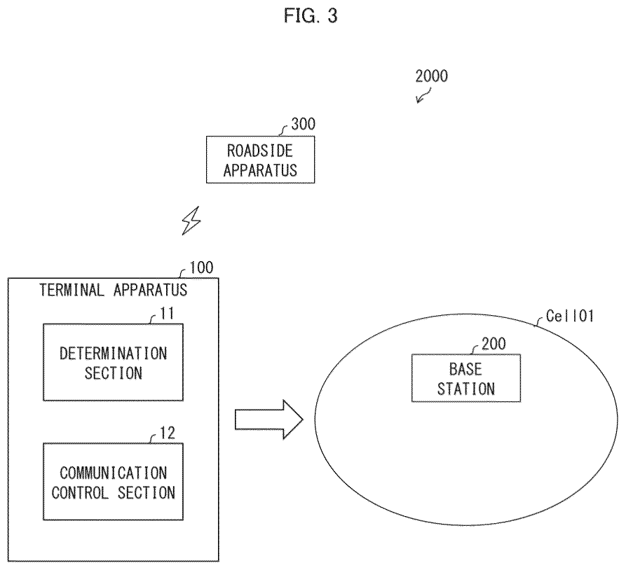

Next, a configuration of a communication system 2000 which is another communication system in accordance with the present example embodiment is described with reference to FIG. 3. FIG. 3 is a drawing illustrating an example of the configuration of the communication system 2000. As illustrated in FIG. 3, the communication system 2000 includes, as an example, a terminal apparatus 100, a base station 200, and a roadside apparatus 300. As illustrated in FIG. 3, the base station 200 provides a cell (Cell01) as a communication area which the base station 200 manages.

As an example, the roadside apparatus 300 is disposed in the vicinity of the cell (Cell01). Note, here, that the expression “vicinity” does not limit the present example embodiment, but, as an example, the roadside apparatus 300 can be disposed outside the boundary of the cell (Cell01) and within the range of 10 m to 100 m from the boundary.

As illustrated in FIG. 3, the terminal apparatus 100 includes a determination section 11 and a communication control section 12. The determination section 11 determines whether the terminal apparatus 100 has approached the cell (Cell01) which the base station 200 manages.

As an example, the roadside apparatus 300 may make a notification with respect to the terminal apparatus 100, and the determination section 11 may determine that the terminal apparatus 100 has approached the cell (Cell01), based on the notification.

In a case where the determination section 11 determines that the terminal apparatus 100 has approached the cell (Cell01), the communication control section 12 increases the frequency of cell searches for connection to the cell (Cell01).

As an example, the communication control section 12 controls a communication module of the terminal apparatus 100 so as to increase the frequency of the cell searches which are conducted by the communication module.

Note that a degree to which the communication control section 12 increases the frequency of the cell searches does not limit the present example embodiment, but an example process is as described in connection with the communication system 1000.

A specific example of a determination of approach which determination is made by the determination section 11 is as described in connection with the communication system 1000.

### (Effect of Communication System 2000)

In the communication system 2000 configured as described above, the terminal apparatus 100 includes the above-described determination section 11 and the above-described communication control section 12. The terminal apparatus 100 thus configured makes it possible to immediately establish connection when the terminal apparatus 100 moves from outside the cell into the cell.

### (Configuration of Communication System 3000)

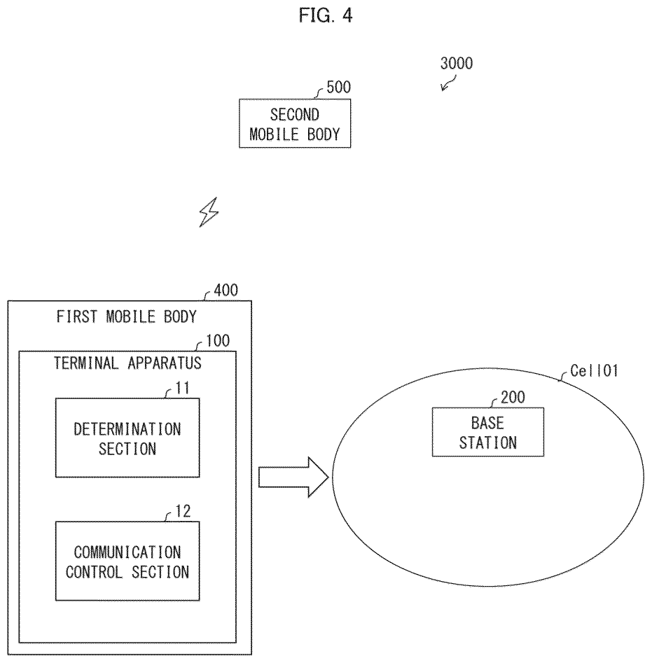

Next, a configuration of a communication system 3000 which is another communication system in accordance with the present example embodiment is described with reference to FIG. 4. FIG. 4 is a drawing illustrating an example of the configuration of the communication system 3000. As illustrated in FIG. 4, the communication system 3000 includes a first mobile body 400, a second mobile body 500, and a base station 200, as an example. As illustrated in FIG. 4, the base station 200 provides a cell (Cell01) as a communication area which the base station 200 manages. Note that each of the first mobile body 400 and the second mobile body 500 may be, as an example, a two-wheel, three-wheel, or four-wheel vehicle or may be another mobile body. These mobile bodies may or may not be controlled by autonomous driving.

As illustrated in FIG. 4, in the communication system 3000, the first mobile body 400 includes the above-described terminal apparatus 100.

In the communication system 3000, as an example, the second mobile body 500 may makes a notification with respect to the terminal apparatus 100, and the determination section 11 of the terminal apparatus 100 may determine that the terminal apparatus 100 has approached the cell (Cell01), based on the notification.

Then, as an example, the communication control section 12 of the terminal apparatus 100 controls a communication module of the terminal apparatus 100 so as to increase the frequency of cell searches which are conducted by the communication module.

Note that a degree to which the communication control section 12 of the terminal apparatus 100 increases the frequency of the cell searches does not limit the present example embodiment, but an example process is as described in connection with the communication system 1000.

A specific example of a determination of approach which determination is made by the determination section 11 is as described in connection with the communication system 1000.

### (Effect of Communication System 3000)

In the communication system 3000 configured as described above, the terminal apparatus 100 includes the above-described determination section 11 and the above-described communication control section 12. The terminal apparatus 100 thus configured makes it possible to immediately establish connection when the terminal apparatus 100 moves from outside the cell into the cell.

### Second Example Embodiment

The following description will discuss a second example embodiment of the present invention in detail with reference to the drawings. Note that constitutional elements having the same functions as those of the constitutional elements described in the first example embodiment are given the same reference signs, and descriptions thereof will be omitted as appropriate.

### (Configuration of Communication System 1000a)

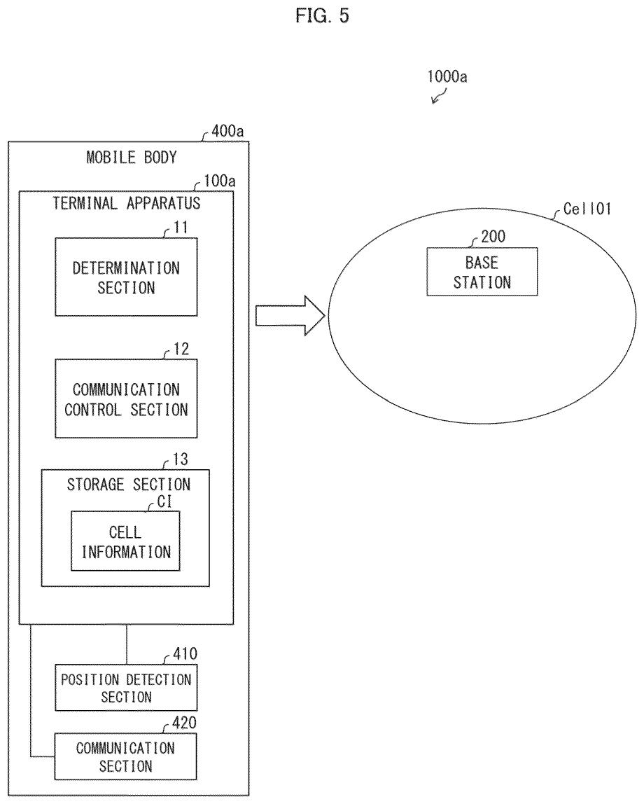

FIG. 5 is a block diagram illustrating a configuration of a communication system 1000a in accordance with the present example embodiment. As illustrated in FIG. 5, the communication system 1000a includes a mobile body 400a and a base station 200, as an example. As illustrated in FIG. 5, the base station 200 provides a cell (Cell01) as a communication area which the base station 200 manages, as in the first example embodiment.

The mobile body 400a may be, as an example, a two-wheel, three-wheel, or four-wheel vehicle or may be another mobile body. The mobile body may or may not be controlled by autonomous driving.

As illustrated in FIG. 5, the mobile body 400a includes a terminal apparatus 100a, a position detection section 410, and a communication section 420. The position detection section 410 includes a reception apparatus which is in conformity with, as an example, the global positioning system (GPS), and can detect the position of the mobile body 400a on the earth. The position detection section 410 supplies, to the terminal apparatus 100a, positional information indicating the detected position.

As an example, in the cell (Cell01) which the base station 200 provides, the communication section 420 carries out communication with the base station 200. As an example, the communication section 420 includes a transmission and reception apparatus which is in conformity with the 4G standard, a transmission and reception apparatus which is in conformity with the 5G standard, or a transmission and reception apparatus which is in conformity with another communication standard. These transmission and reception apparatuses (also referred to as a transmission and reception module or a communication module) are controlled by the terminal apparatus 100a, as an example. Note that a configuration of the mobile body 400a illustrated in FIG. 5 is merely an example, and, for example, the terminal apparatus 100a may include at least one of the position detection section 410 and the communication section 420.

### (Terminal Apparatus 100a)

The terminal apparatus 100a includes a determination section 11, a communication control section 12, and a storage section 13, as illustrated in FIG. 5. The determination section 11 and the communication control section 12 are configurations which realize a determination means and a communication control means, respectively, in the present example embodiment. Note, here, that cell information CI is stored in the storage section 13, as illustrated in FIG. 5. The cell information CI includes information pertaining to the base station 200 and the other plurality of base stations (not illustrated). As an example, the cell information CI includes positional information pertaining to the base station 200 and the other plurality of base stations (not illustrated).

As with the determination section described in the first example embodiment, the determination section 11 determines whether the terminal apparatus 100a (in other words, the mobile body 400a) has approached the cell (Cell01) which the base station 200 manages. More specifically, the determination section 11 may determine whether the terminal apparatus 100a has approached the cell (Cell01), based on a result of comparing (i) the positional information indicating the position of the mobile body 400a which position has been detected by the position detection section 410 (in other words, positional information pertaining to the terminal apparatus 100a) and (ii) the positional information that is included in the cell information CI and that is associated with the cell (Cell01) which the base station 200 manages.

As with the communication control section described in the first example embodiment, in a case where the determination section 11 determines that the terminal apparatus 100a (in other words, the mobile body 400a) has approached the cell (Cell01), the communication control section 12 increases the frequency of cell searches which are conducted by the communication section 420 for connection to the cell (Cell01).

Note that the configuration of the mobile body 400a illustrated in FIG. 5 is merely an example, and the mobile body 400a may directly include each section of the terminal apparatus 100a described above.

### (Example Process 1 Carried Out by Communication Control Section 12)

An example process carried out by the communication control section 12 is not limited to the above-described example. For example, the communication control section 12 may change a timing at which the communication control section 12 increases the frequency of the cell searches, in accordance with a speed of movement of the terminal apparatus 100a or the mobile body 400a to which the terminal apparatus 100a is mounted.

Note, here, that the communication control section 12 can calculate the speed of the movement of the terminal apparatus 100a or the mobile body 400a from, as an example, a temporal change in positional information indicating the position of the mobile body 400a which position is detected by the position detection section 410.

In the present example process, the communication control section 12 may make the timing at which the communication control section 12 increases the frequency of the cell searches earlier, as the speed of the movement of the terminal apparatus 100a or the mobile body 400a to which the terminal apparatus 100a is mounted becomes higher.

For example, the following configuration may be employed.
In a case where the speed of the movement of the mobile body 400a is 30 km/h to 50 km/h, the communication control section 12 increases the frequency of the cell searches at a timing at which a distance from the boundary of the cell becomes 100 m.
In a case where the speed of the movement of the mobile body 400a is 10 km/h to 30 km/h, the communication control section 12 increases the frequency of the cell searches at a timing at which the distance from the boundary of the cell becomes 50 m.
In a case where the speed of the movement of the mobile body 400a is 5 km/h to 10 km/h, the communication control section 12 increases the frequency of the cell searches at a timing at which the distance from the boundary of the cell becomes 30 m.

Note that the “speed” of the mobile body 400a in the above description may be read as “velocity”. In the case of such a configuration, the communication control section 12 changes the timing at which the communication control section 12 increases the frequency of the cell searches, in accordance with the direction and the speed of the movement of the terminal apparatus 100a or the mobile body 400a to which the terminal apparatus 100a is mounted. In the case of such a configuration, in a case where the mobile body 400a approaches the base station 200, the communication control section 12 carries out the above-described control, and, in a case where the mobile body 400a moves away from the base station 200, the communication control section 12 can also carry out control in which the communication control section 12 does not change the frequency of the cell searches.

### (Example Process 2 Carried Out by Communication Control Section 12)

Further, the communication control section 12 may change the frequency of the cell searches, in accordance with the speed of the movement of the terminal apparatus 100a or the mobile body 400a to which the terminal apparatus 100a is mounted.

As an example, the communication control section 12 may increase the frequency of the cell searches, as the speed of the movement of the terminal apparatus 100a or the mobile body 400a to which the terminal apparatus 100a is mounted becomes higher.

For example, in a case where the frequency of the cell searches when the determination section 11 determines that the target terminal apparatus 100a is not approaching the cell (Cell01) which the base station 200 manages is expressed as F1 and the frequency of the cell searches when the determination section 11 determines that the terminal apparatus 100a has approached the cell (Cell01) which the base station 200 manages is expressed as F2, the increase in frequency of the cell searches can be expressed as below with use of a coefficient α greater than 1.

$$F 2 = α \cdot F 1$$

In the present example process, the following configuration may be employed.
In a case where the speed of the movement of the mobile body 400a is 30 km/h to 50 km/h, a is set to 10.
In a case where the speed of the movement of the mobile body 400a is 10 km/h to 30 km/h, a is set to 5.
In a case where the speed of the movement of the mobile body 400a is 5 km/h to 10 km/h, a is set to 2.

Note that, as in the example process 1, the “speed” of the mobile body 400a in the above description may be read as “velocity”. In the case of such a configuration, the communication control section 12 changes the frequency of the cell searches, in accordance with the direction and the speed of the movement of the terminal apparatus 100a or the mobile body 400a to which the terminal apparatus 100a is mounted. In the case of such a configuration, in a case where the mobile body 400a approaches the base station 200, the communication control section 12 carries out the above-described control, and, in a case where the mobile body 400a moves away from the base station 200, the communication control section 12 can also carry out control in which the communication control section 12 does not change the frequency of the cell searches.

### (Example Process 3 Carried Out by Communication Control Section 12)

In a case where the terminal apparatus 100a or the mobile body 400a to which the terminal apparatus 100a is mounted stops outside the range of the cell (Cell01) which the base station 200 manages, the communication control section 12 may carry out control in which the communication control section 12 does not change the frequency of the cell searches.

### (Effect of Communication System 1000a)

In the communication system 1000a configured as described above, the terminal apparatus 100a includes the above-described determination section 11 and the above-described communication control section 12. The terminal apparatus 100a thus configured makes it possible to immediately establish connection when the terminal apparatus 100a moves from outside the cell into the cell.

### Third Example Embodiment

The following description will discuss a third example embodiment of the present invention in detail with reference to the drawings. Note that constitutional elements having the same functions as those of the constitutional elements described in the first example embodiment are given the same reference signs, and descriptions thereof will be omitted as appropriate.

### (Configuration of Communication System 1000b)

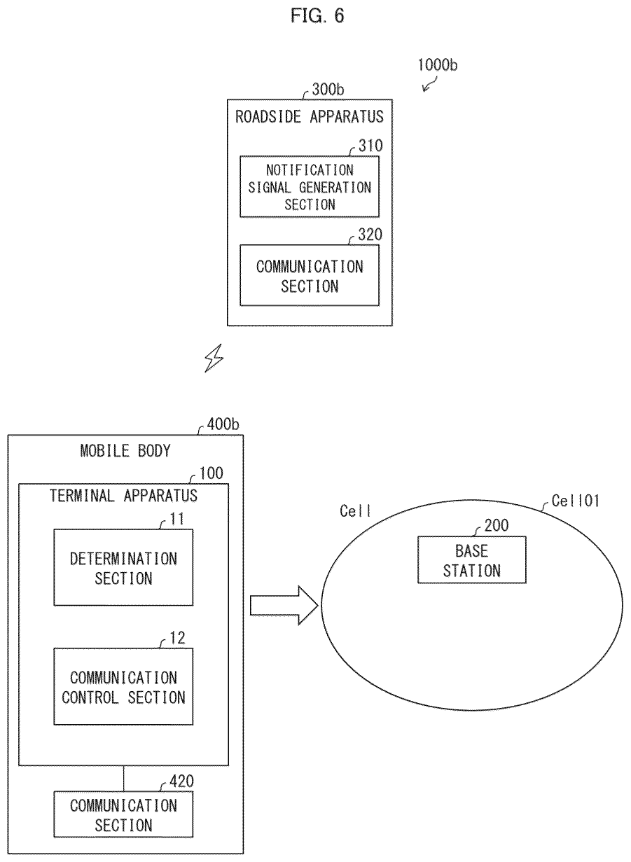

FIG. 6 is a block diagram illustrating a configuration of a communication system 1000b in accordance with the present example embodiment. As illustrated in FIG. 6, the communication system 1000b includes a mobile body 400b, a base station 200, and a roadside apparatus 300b, as an example. As illustrated in FIG. 6, the base station 200 provides a cell (Cell01) as a communication area which the base station 200 manages, as in the first example embodiment.

As an example, the roadside apparatus 300b is disposed in the vicinity of the cell (Cell01). Note, here, that the expression “vicinity” does not limit the present example embodiment, but, as an example, the roadside apparatus 300b can be disposed outside the boundary of the cell (Cell01) and within the range of 10 m to 100 m from the boundary.

As illustrated in FIG. 6, the roadside apparatus 300b includes a notification signal generation section 310 and a communication section 320. The notification signal generation section 310 generates a signal of which the mobile body 400b is notified, and the communication section 320 carries out communication with a communication section 420 of the mobile body 400b.

The mobile body 400b may be, as an example, a two-wheel, three-wheel, or four-wheel vehicle or may be another mobile body. The mobile body may or may not be controlled by autonomous driving.

As illustrated in FIG. 6, the mobile body 400b includes a terminal apparatus 100 and the communication section 420. As an example, the communication section 420 carries out communication with the communication section 320 of the roadside apparatus 300b, and includes a transmission and reception apparatus which is in conformity with the 4G standard, a transmission and reception apparatus which is in conformity with the 5G standard, or a transmission and reception apparatus which is in conformity with another communication standard. These transmission and reception apparatuses (also referred to as a transmission and reception module or a communication module) are controlled by the terminal apparatus 100, as an example. Note that configuration of the mobile body 400b illustrated in FIG. 6 is merely an example, and, for example, the terminal apparatus 100 may include the communication section 420.

### (Terminal Apparatus 100)

The terminal apparatus 100 includes a determination section 11 and a communication control section 12, as illustrated in FIG. 6. The determination section 11 and the communication control section 12 are configurations which realize a determination means and a communication control means, respectively, in the present example embodiment.

As with the determination section described in the first example embodiment, the determination section 11 determines whether the target terminal apparatus 100 (in other words, the mobile body 400b) has approached the cell (Cell01) which the base station 200 manages. More specifically, the determination section 11 may determine that the terminal apparatus 100 has approached the cell (Cell01), based on a notification from the roadside apparatus 300b that is provided in the vicinity of the cell (Cell01) which the base station 200 manages.

As with the communication control section described in the first example embodiment, in a case where the determination section 11 determines that the terminal apparatus 100 (in other words, the mobile body 400b) has approached the cell (Cell01), the communication control section 12 increases the frequency of cell searches which are conducted by the communication section 420 for connection to the cell (Cell01).

Note that the configuration of the mobile body 400b illustrated in FIG. 6 is merely an example, and the mobile body 400b may directly include each section of the terminal apparatus 100 described above.

### (Example Process Carried Out by Communication Control Section 12)

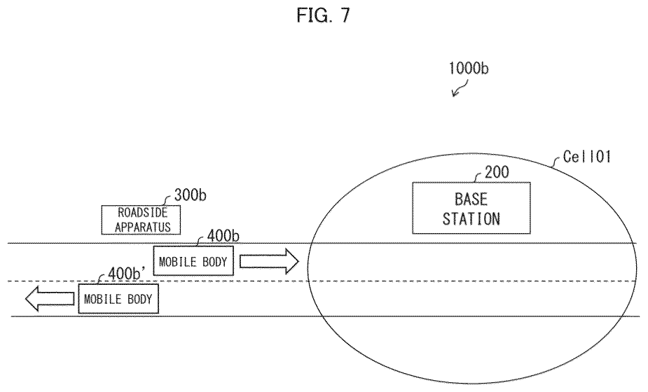

Here, an example process carried out by the communication control section 12 will be described in detail with reference to FIG. 7. FIG. 7 is a drawing illustrating movement of mobile bodies 400b during a determination process in the communication system 1000b. More specifically, FIG. 7 is a drawing illustrating the mobile bodies which are different in traveling direction in the vicinity of the base station 200. As illustrated in FIG. 7, the traveling direction of the mobile body 400b is a direction toward the base station 200 (in other words, a direction toward the cell (Cell01)). Alternatively, as illustrated in FIG. 7, the traveling direction of the mobile body 400b′ is a direction other than the direction toward the base station 200 (in other words, a direction away from the cell (Cell01)).

For example, the roadside apparatus 300b broadcasts the notification which includes a condition pertaining to the traveling direction of the mobile body 400b. The determination section 11 of the terminal apparatus 100 receives, from the roadside apparatus 300b, the notification which includes the condition pertaining to the traveling direction of the mobile body 400b. In a case where the condition is satisfied, the determination section 11 determines that the target terminal apparatus 100 has approached the cell (Cell01).

More specifically, the notification signal generation section 310 of the roadside apparatus 300b generates, as an example, the following notification signal including a condition.
In a case where the traveling direction of the mobile body is a given direction, the frequency of the cell searches is increased. Note, here, that a part “In the case where the traveling direction of the mobile body is a given direction” corresponds to the condition. Note that the expression “given direction” does not limit the present example embodiment, but, as an example, can be the direction in which the base station 200 is located (in other words, the direction in which the cell (Cell01) is located), from the position where the roadside apparatus 300b is disposed.

The communication section 320 of the roadside apparatus 300b notifies the communication section 420 of the mobile body 400b of the notification signal generated by the notification signal generation section 310.

The determination section 11 determines whether the condition included in the notification signal is satisfied, based on the notification received from the roadside apparatus 300b. More specifically, as illustrated in FIG. 7, in a case where the traveling direction of the mobile body 400b is the direction toward the base station 200, the determination section 11 determines that the traveling direction of the mobile body 400b matches the given direction. Alternatively, in a case where, as illustrated in FIG. 7, the traveling direction of the mobile body 400b′ is different from the direction toward the base station 200, the determination section 11 determines that the traveling direction of the mobile body 400b′ does not match the given direction.

In a case where the determination section 11 determines that the traveling direction of the mobile body 400b matches the given direction, the communication control section 12 increases the frequency of the cell searches. In a case where the determination section 11 determines that the traveling direction of the mobile body 400b does not match the given direction, the communication control section 12 does not change the frequency of the cell searches.

Note that, in the communication system 1000b of the present example embodiment, the mobile body 400b may further include a position detection section 410, as in the second example embodiment. In a case where the mobile body 400b has such as configuration, the notification signal generation section 310 may generate, as an example, the following as a communication signal.
Positional information pertaining to the base station 200 (in other words, positional information associated with the cell (Cell01) which the base station 200 manages)

The determination section 11 determines whether the terminal apparatus 100 has approached the cell (Cell01), based on the notification received from the roadside apparatus 300b. More specifically, the determination section 11 determines whether the terminal apparatus 100 has approached the cell (Cell01), based on a result of comparing (i) positional information indicating the position of the mobile body 400b which position has been detected by the position detection section 410 (in other words, positional information pertaining to the terminal apparatus 100) and (ii) the positional information that has been received from the roadside apparatus 300b and that pertains to the base station 200 (in other words, positional information associated with the cell (Cell01) which the base station 200 manages).

In a case where the determination section 11 determines that the terminal apparatus 100 (in other words, the mobile body 400b) has approached the cell (Cell01), the communication control section 12 increases the frequency of the cell searches. In a case where the determination section 11 determines that the terminal apparatus 100a (in other words, the mobile body 400a) is moving away from the cell (Cell01), the communication control section 12 does not change the frequency of the cell searches.

### (Effect of Communication System 1000b)

In the communication system 1000b configured as described above, the terminal apparatus 100 includes the above-described determination section 11 and the above-described communication control section 12. The terminal apparatus 100 thus configured makes it possible to immediately establish connection when the terminal apparatus 100 moves from outside the cell into the cell.

### Fourth Example Embodiment

The following description will discuss a fourth example embodiment of the present invention in detail with reference to the drawings. Note that constitutional elements having the same functions as those of the constitutional elements described in the first example embodiment are given the same reference signs, and descriptions thereof will be omitted as appropriate.

### (Configuration of Communication System 1000c)

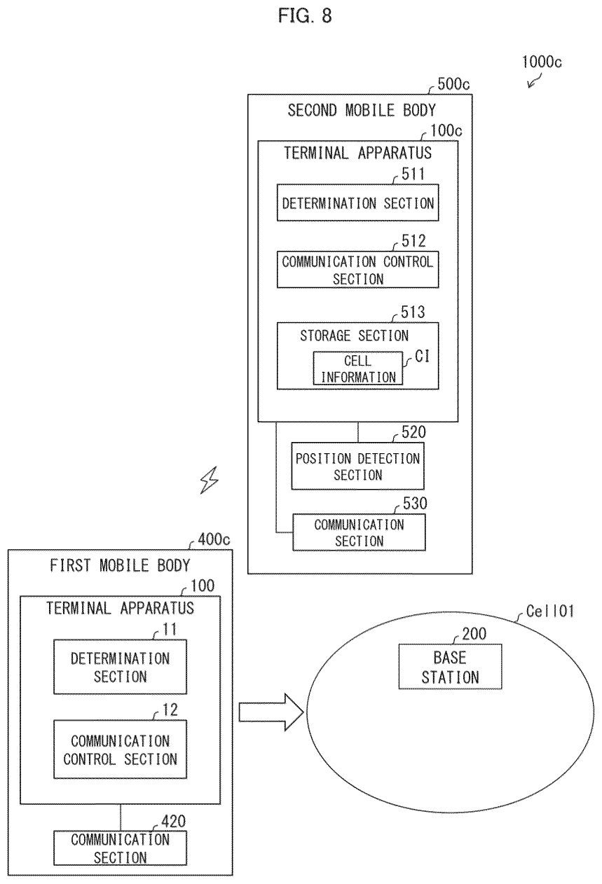

FIG. 8 is a block diagram illustrating a configuration of a communication system 1000c in accordance with the present example embodiment. As illustrated in FIG. 8, the communication system 1000c includes a first mobile body 400c, a second mobile body 500c, and a base station 200, as an example. As illustrated in FIG. 8, the base station 200 provides a cell (Cell01) as a communication area which the base station 200 manages. Note that each of the first mobile body 400c and the second mobile body 500c may be, as an example, a two-wheel, three-wheel, or four-wheel vehicle or may be another mobile body. These mobile bodies may or may not be controlled by autonomous driving.

As illustrated in FIG. 8, the second mobile body 500c includes a terminal apparatus 100c, a position detection section 520, and a communication section 530. As illustrated in FIG. 8, the terminal apparatus 100c includes a determination section 511, a communication control section 512, and a storage section 513. Note, here, that the terminal apparatus 100c, the position detection section 520, the communication section 530, the determination section 511, the communication control section 512, and the storage section 513 are configurations corresponding to the terminal apparatus 100a, the position detection section 410, the communication section 420, the determination section 11, the communication control section 12, and the storage section 13, respectively, described in the second example embodiment. In the present example embodiment, descriptions of constitutional elements having the same functions as those of the constitutional elements described in the second example embodiment, among the constituent elements of the second mobile body 500c, will be omitted as appropriate.

As with the communication control section described in the second example embodiment, in a case where the determination section 511 determines that the terminal apparatus 100c (in other words, the second mobile body 500c) has approached the cell (Cell01), the communication control section 512 of the second mobile body 500c increases the frequency of cell searches which are conducted by the communication section 530 for connection to the cell (Cell01). The communication control section 512 also generates a signal of which another mobile body (in other words, the first mobile body 400c) is notified.

As with the communication section described in the second example embodiment, the communication section 530 of the second mobile body 500c carries out communication with the base station 200 in the cell (Cell01) which the base station 200 provides. The communication section 530 also carries out communication with a communication section 420 of the first mobile body 400c.

As illustrated in FIG. 8, the first mobile body 400c includes a terminal apparatus 100 and the communication section 420. As an example, the communication section 420 carries out communication with the communication section 530 of the second mobile body 500c, and includes a transmission and reception apparatus which is in conformity with the 4G standard, a transmission and reception apparatus which is in conformity with the 5G standard, or a transmission and reception apparatus which is in conformity with another communication standard. These transmission and reception apparatuses (also referred to as a transmission and reception module or a communication module) are controlled by the terminal apparatus 100, as an example. Note that a configuration of the first mobile body 400c illustrated in FIG. 8 is merely an example, and, for example, the terminal apparatus 100 may include the communication section 420.

### (Terminal Apparatus 100)

The terminal apparatus 100 includes a determination section 11 and a communication control section 12, as illustrated in FIG. 8. The determination section 11 and the communication control section 12 are configurations which realize a determination means and a communication control means, respectively, in the present example embodiment.

As with the determination section described in the second example embodiment, the determination section 11 determines whether the target terminal apparatus 100 (in other words, the first mobile body 400c) has approached the cell (Cell01) which the base station 200 manages. More specifically, the determination section 11 may determine that the target terminal apparatus 100 has approached the cell (Cell01), based on a notification from another mobile body (second mobile body 500c) that is different from the mobile body (first mobile body 400c) to which the target terminal apparatus 100 is mounted.

As with the communication control section described in the first example embodiment, in a case where the determination section 11 determines that the terminal apparatus 100 (in other words, the first mobile body 400c) has approached the cell (Cell01), the communication control section 12 increases the frequency of cell searches which are conducted by the communication section 420 for connection to the cell (Cell01).

Note that the configuration of the first mobile body 400c illustrated in FIG. 8 is merely an example, and the first mobile body 400c may directly include each section of the terminal apparatus 100 described above.

### (Example Process Carried Out by Communication Control Section 12)

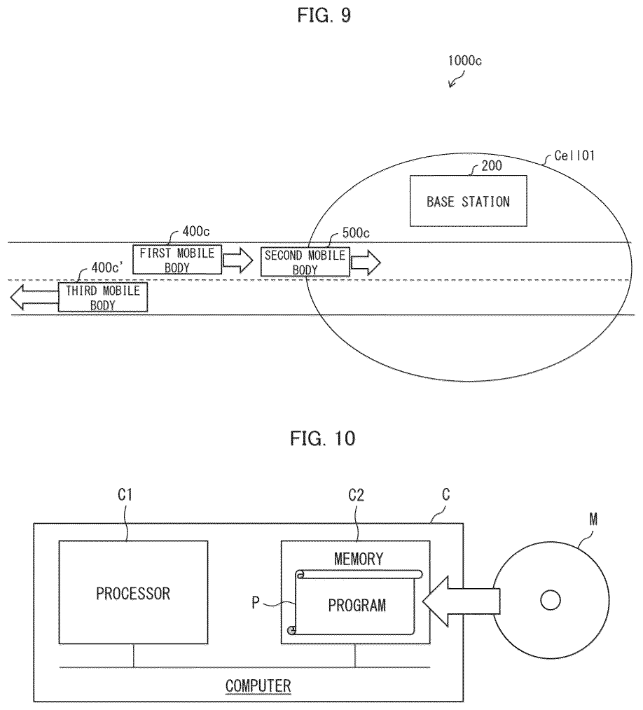

Here, an example process carried out by the communication control section 12 will be described in detail with reference to FIG. 9. FIG. 9 is a drawing illustrating movement of mobile bodies during a determination process in the communication system 1000c. More specifically, FIG. 9 is a drawing illustrating the mobile bodies which are different in traveling direction in the vicinity of the base station 200. As illustrated in FIG. 9, the traveling direction of the first mobile body 400c is a direction toward the base station 200 (in other words, a direction toward the cell (Cell01)). As illustrated in FIG. 9, the traveling direction of the second mobile body 500c is a direction toward the base station 200 (in other words, a direction toward the cell (Cell01)). Alternatively, as illustrated in FIG. 9, the traveling direction of a third mobile body 400c′ is a direction other than the direction toward the base station 200 (in other words, a direction away from the cell (Cell01)).

For example, the determination section 11 receives, from the second mobile body 500c, the notification which includes a condition pertaining to the traveling direction of the first mobile body 400c. In a case where the condition is satisfied, the determination section 11 determines that the target terminal apparatus 100 has approached the cell (Cell01).

More specifically, in a case where the determination section 511 of the second mobile body 500c increases the frequency of the cell searches which are conducted by the communication section 530 of the second mobile body 500c, the communication control section 512 of the second mobile body 500c generates, as an example, the following notification signal including a condition.
In a case where the traveling direction of another mobile body is a given direction, the frequency of the cell searches is increased.
   Note, here, that a part “In a case where the traveling direction of another mobile body is a given direction” corresponds to the condition. Note that the expression “given direction” does not limit the present example embodiment, but, as an example, can be the traveling direction of the second mobile body 500c (in other words, the direction in which the cell (Cell01) is located).

The communication section 530 of the second mobile body 500c notifies the communication section 420 of the first mobile body 400c of the notification signal generated by the communication control section 512.

The determination section 11 determines whether the condition included in the notification signal is satisfied, based on the notification received from the second mobile body 500c. More specifically, as illustrated in FIG. 9, in a case where the traveling direction of the first mobile body 400c matches the traveling direction of the second mobile body 500c, the determination section 11 determines traveling direction of the mobile body 400b matches the given direction. Alternatively, in a case where, as illustrated in FIG. 9, the traveling direction of the third mobile body 400c′ is different from the traveling direction of the second mobile body 500c, the determination section 11 determines that the traveling direction of the third mobile body 400c′ does not match the given direction.

In a case where the determination section 11 determines that the traveling direction of the first mobile body 400c matches the given direction, the communication control section 12 increases the frequency of the cell searches. In a case where the determination section 11 determines that the traveling direction of the first mobile body 400c does not match the given direction, the communication control section 12 does not change the frequency of the cell searches.

### (Effect of Communication System 1000c)

In the communication system 1000c configured as described above, the terminal apparatus 100 includes the above-described determination section 11 and the above-described communication control section 12. The terminal apparatus 100 thus configured makes it possible to immediately establish connection when the terminal apparatus 100 moves from outside the cell into the cell.

### Software Implementation Example

Some or all of the functions of the communication control apparatus 1, the terminal apparatuses 100, 100a, and 100c, and the roadside apparatuses 300 and 300b may be realized by hardware such as an integrated circuit (IC chip) or may be alternatively realized by software.

In the latter case, the communication control apparatus 1, the terminal apparatuses 100, 100a, and 100c, and the roadside apparatuses 300 and 300b are realized by, for example, a computer that executes instructions of a program that is software realizing the functions. FIG. 10 illustrates an example of such a computer (hereinafter, referred to as “computer C”). The computer C includes at least one processor C1 and at least one memory C2. In the memory C2, a program P for causing the computer C to operate as the communication control apparatus 1, the terminal apparatuses 100, 100a, and 100c, and the roadside apparatuses 300 and 300b is recorded. In the computer C, the processor C1 reads the program P from the memory C2 and executes the program P, so that the functions of the communication control apparatus 1, the terminal apparatuses 100, 100a, and 100c, and the roadside apparatuses 300 and 300b are realized.

The processor C1 can be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 can be, for example, a flash memory, a hard disk drive (HDD), a solid state drive (SSD), or a combination of these.

Note that the computer C may further include a random access memory (RAM) in which the program P is loaded when the program P is executed and in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The program P can also be recorded in a non-transitory tangible recording medium M from which the computer C can read the program P. The recording medium M can be, for example, a tape, a disk, a card, a semiconductor memory, a programmable logic circuit, or the like. The computer C can obtain the program P via the recording medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments. As an example, the present invention may be configured such that, when the determination section determines whether the target terminal apparatus has approached the cell which the base station manages, at least two or more of the determination processes described in the first through fourth example embodiments are used in combination.

### [Additional Remark 2]

Some or all of the foregoing example embodiments can also be described as follows. Note, however, that the present invention is not limited to the following aspects.

### (Supplementary Note 1)

A communication control apparatus including: a determination means for determining whether a target terminal apparatus has approached a cell which a base station manages; and a communication control means for increasing a frequency of cell searches which are conducted by the target terminal apparatus for connection to the cell, in a case where the determination means determines that the target terminal apparatus has approached the cell.

### (Supplementary Note 2)

The communication control apparatus as described in Supplementary note 1, wherein a determination process carried out by the determination means includes a process of determining whether the target terminal apparatus has approached the cell, based on a result of comparing (i) positional information pertaining to the target terminal apparatus or positional information pertaining to a mobile body to which the target terminal apparatus is mounted and (ii) positional information associated with the cell which the base station manages.

### (Supplementary Note 3)

The communication control apparatus as described in Supplementary note 1 or 2, wherein a determination process carried out by the determination means includes a process of determining that the target terminal apparatus has approached the cell, based on a notification from a roadside apparatus that is provided in a vicinity of the cell which the base station manages.

### (Supplementary Note 4)

The communication control apparatus as described in any one of Supplementary notes 1 through 3, wherein a determination process carried out by the determination means includes a process of determining that the target terminal apparatus has approached the cell, based on a notification from another mobile body that is different from a mobile body to which the target terminal apparatus is mounted.

### (Supplementary Note 5)

The communication control apparatus as described in Supplementary note 3 or 4, wherein the notification includes a condition pertaining to a traveling direction of a mobile body, and in a case where the condition is satisfied, the determination means determines that the target terminal apparatus has approached the cell.

### (Supplementary Note 6)

The communication control apparatus as described in any one of Supplementary notes 1 through 5, wherein the communication control means changes a timing at which the communication control means increases the frequency of the cell searches, in accordance with a speed of movement of the target terminal apparatus or a mobile body to which the target terminal apparatus is mounted.

### (Supplementary Note 7)

The communication control apparatus as described in any one of Supplementary notes 1 through 6, wherein the communication control means makes a timing at which the communication control means increases the frequency of the cell searches earlier, as a speed of movement of the target terminal apparatus or a mobile body to which the target terminal apparatus is mounted becomes higher.

### (Supplementary Note 8)

The communication control apparatus as described in any one of Supplementary notes 1 through 7, wherein the communication control means changes the frequency of the cell searches in accordance with a speed of movement of the target terminal apparatus or a mobile body to which the target terminal apparatus is mounted.

### (Supplementary Note 9)

The communication control apparatus as described in Supplementary note 8, wherein the communication control means increases the frequency of the cell searches, as the speed of the movement of the target terminal apparatus or the mobile body to which the target terminal apparatus is mounted becomes higher.

### (Supplementary Note 10)

A terminal apparatus including: a determination means for determining whether the terminal apparatus has approached a cell which a base station manages; and a communication control means for increasing a frequency of cell searches for connection to the cell, in a case where the determination means determines that the terminal apparatus has approached the cell.

### (Supplementary Note 11)

A mobile body including: a determination means for determining whether the mobile body has approached a cell which a base station manages; and a communication control means for increasing a frequency of cell searches for connection to the cell, in a case where the determination means determines that the mobile body has approached the cell.

### (Supplementary Note 12)

A communication system including a terminal apparatus and a roadside apparatus, the terminal apparatus including: a determination means for determining whether the terminal apparatus has approached a cell which a base station manages; and a communication control means for increasing a frequency of cell searches for connection to the cell, in a case where the determination means determines that the terminal apparatus has approached the cell, the roadside apparatus making a notification with respect to the terminal apparatus, the determination means determining that the terminal apparatus has approached the cell, based on the notification.

### (Supplementary Note 13)

A communication system including a terminal apparatus and another mobile body that is different from a mobile body to which the terminal apparatus is mounted, the terminal apparatus including: a determination means for determining whether the terminal apparatus has approached a cell which a base station manages; and a communication control means for increasing a frequency of cell searches for connection to the cell, in a case where the determination means determines that the terminal apparatus has approached the cell, the another mobile body making a notification with respect to the terminal apparatus, the determination means determining that the terminal apparatus has approached the cell, based on the notification.

### (Supplementary Note 14)

A communication control method carried out by a communication control apparatus, including: determining whether a target terminal apparatus has approached a cell which a base station manages; and increasing a frequency of cell searches which are conducted by the target terminal apparatus for connection to the cell, in a case where a determination means determines that the target terminal apparatus has approached the cell.

### (Supplementary Note 15)

A program for causing a computer to function as a communication control apparatus, the program causing the computer to function as: a determination means for determining whether a target terminal apparatus has approached a cell which a base station manages; and a communication control means for increasing a frequency of cell searches which are conducted by the target terminal apparatus for connection to the cell, in a case where the determination means determines that the target terminal apparatus has approached the cell.

### [Additional Remark 3]

Some or all of the foregoing example embodiments can also be expressed as follows.

A communication control apparatus including at least one processor, the at least one processor carrying out: a determination process of determining whether a target terminal apparatus has approached a cell which a base station manages; and a communication control process of increasing a frequency of cell searches which are conducted by the target terminal apparatus for connection to the cell, in a case where it is determined, in the determination process, that the target terminal apparatus has approached the cell.

Note that the communication control apparatus may further include a memory. In the memory, a program for causing the at least one processor to carry out the determination process and the communication control process may be stored. The program may be recorded in a computer-readable non-transitory tangible recording medium.

### REFERENCE SIGNS LIST

1 Communication control apparatus
11 Determination section
12 Communication control section
100, 100a Terminal apparatus
200 Base station
300, 300b Roadside apparatus
400, 400a, 400b Mobile body (first mobile body)
500 Mobile body (second mobile body)
1000, 1000a, 1000b, 1000c, 2000, 3000 Communication system
Cell01 Cell

What is claimed is:

1. A communication control apparatus comprising
at least one processor,
the at least one processor carrying out:
a determination process of determining whether a target terminal apparatus has approached a cell which a base station manages; and
a communication control process of increasing a frequency of cell searches which are conducted by the target terminal apparatus for connection to the cell, in a case where, in the determination process, it is determined that the target terminal apparatus has approached the cell.

2. The communication control apparatus as set forth in claim 1, wherein
the determination process includes
a process of determining whether the target terminal apparatus has approached the cell, based on a result of comparing (i) positional information pertaining to the target terminal apparatus or positional information pertaining to a mobile body to which the target terminal apparatus is mounted and (ii) positional information associated with the cell which the base station manages.

3. The communication control apparatus as set forth in claim 1, wherein
the determination process includes
a process of determining that the target terminal apparatus has approached the cell, based on a notification from a roadside apparatus that is provided in a vicinity of the cell which the base station manages.

4. The communication control apparatus as set forth in claim 1, wherein
the determination process includes
a process of determining that the target terminal apparatus has approached the cell, based on a notification from another mobile body that is different from a mobile body to which the target terminal apparatus is mounted.

5. The communication control apparatus as set forth in claim 3, wherein
the notification includes a condition pertaining to a traveling direction of a mobile body, and
in a case where the condition is satisfied, it is determined, in the determination process, that the target terminal apparatus has approached the cell.

6. The communication control apparatus as set forth in claim 1, wherein, in the communication control process, a timing at which the frequency of the cell searches is increased is changed in accordance with a speed of movement of the target terminal apparatus or a mobile body to which the target terminal apparatus is mounted.

7. The communication control apparatus as set forth in claim 1, wherein, in the communication control process, a timing at which the frequency of the cell searches is increased is made earlier, as a speed of movement of the target terminal apparatus or a mobile body to which the target terminal apparatus is mounted becomes higher.

8. The communication control apparatus as set forth in claim 1, wherein, in the communication control process, the frequency of the cell searches is changed in accordance with a speed of movement of the target terminal apparatus or a mobile body to which the target terminal apparatus is mounted.

9. The communication control apparatus as set forth in claim 8, wherein, in the communication control process, the frequency of the cell searches is increased, as the speed of the movement of the target terminal apparatus or the mobile body to which the target terminal apparatus is mounted becomes higher.

10. A terminal apparatus comprising
at least one processor,
the at least one processor carrying out:
a determination process of determining whether the terminal apparatus has approached a cell which a base station manages; and
a communication control process of increasing a frequency of cell searches for connection to the cell, in a case where, in the determination process, it is determined that the terminal apparatus has approached the cell.

11-13. (canceled)

14. A communication control method carried out by a communication control apparatus, comprising:
determining whether a target terminal apparatus has approached a cell which a base station manages; and
increasing a frequency of cell searches which are conducted by the target terminal apparatus for connection to the cell, in a case where it is determined that the target terminal apparatus has approached the cell.

15. A non-transitory recording medium which stores therein a program for causing a computer to carry out a process as a communication control apparatus, recited in claim 1.
